(19) United States
(12) Patent Application Publication
(10) Pub. No.: US 2012/0111785 A1
(43) Pub. Date: May 10, 2012

(54) VERTICAL DESALINATION ELEMENT

(75) Inventors: Erez Reuveni, Kibbutz Ein Hahoresh (IL); Jacob Ben-Yaish, Zoran (IL); Boris Liberman, Even Yehuda (IL); Miriam Brusilovsky, Ra'anana (IL); Elazar Schwarcz, Natanya (IL)

(73) Assignee: I.D.E. TECHNOLOGIES LTD., Kadima (IL)

(21) Appl. No.: 13/384,241

(22) PCT Filed: Jul. 15, 2010
(86) PCT No.: PCT/IB10/53228

§ 371 Date: Jan. 16, 2012

Related U.S. Application Data
(60) Provisional application No. 61/225,948, filed on Jul. 16, 2009.

(51) Int. Cl. B01D 35/30; B23P 11/00

(52) U.S. Cl. 210/232; 29/428

(57) ABSTRACT

A vertical desalination element comprising a vertical pressure vessel (PV), membrane elements, and a loading mechanism for loading the membrane elements into the vertical PV. The vertical arrangement of the membrane elements and the vertical PV enhances air bubble percolation, increases construction efficiency and allow handling heavy membrane elements. The membrane elements may be loaded singly or groupwise, from either the upper or the lower end of the vertical PV. The loading mechanism may comprise various appliances and devices for supporting and securing the membrane elements, and may apply various ways of loading and releasing the membrane elements.

### CROSS REFERENCE TO RELATED APPLICATIONS

This application claims the benefit of U.S. Provisional Patent Application 61/225,948 filed on Jul. 16, 2009, which is incorporated herein by reference.

### BACKGROUND

1. Technical Field

The present invention relates to the field of desalination, and more particularly, to a vertical desalination element.

2. Discussion of Related Art

Current desalination plants at industrial scales use horizontal pressure vessels fitted with relatively small membrane elements. Scaling up desalination plants demands using larger membrane elements.

WIPO publication No. 2009087642, which is incorporated herein by reference in its entirety, discloses a desalination system with vertical elements.

### BRIEF SUMMARY

Embodiments of the present invention provide a desalination element comprising: a vertical pressure vessel (PV) having a vertical axis, an upper end and a lower end; a plurality of membrane elements operable within the vertical PV; and a loading mechanism arranged to allow loading the membrane elements into the vertical PV, wherein the vertical arrangement of the membrane elements and the vertical PV is usable to enhance air bubble percolation, to increase construction efficiency and to allow handling heavy membrane elements.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a schematic block diagram illustrating an overview of loading mechanisms and loading methods for a desalination element, according to some embodiments of the invention;

FIGS. 2A-2J are schematic block diagrams illustrating a desalination element with a loading mechanism comprising an holder and stages of loading the vertical PV with the membrane elements, according to some embodiments of the invention;

FIGS. 3A-3L are schematic block diagrams illustrating a desalination element with a loading mechanism comprising using a telescopic piston and stages of loading the vertical PV with the membrane elements, according to some embodiments of the invention;

FIGS. 4A-4N are schematic block diagrams illustrating a desalination element with a loading mechanism comprising using a temporary support and stages of loading the vertical PV with the membrane elements, according to some embodiments of the invention; of which FIGS. 4L-4N are schematic illustrations of the temporary support, according to some embodiments of the invention;

FIGS. 5A-5D are schematic block diagrams illustrating the interconnection of membrane elements, according to some embodiments of the invention; FIGS. 5E-5H are schematic block diagrams illustrating a desalination element with a loading mechanism comprising a releasable fastener, and stages of loading the vertical PV with the membrane elements, according to some embodiments of the invention; and FIGS. 5I-5M are schematic illustrations of a releasable fastener, according to some embodiments of the invention;

FIGS. 6A-6D are schematic block diagrams illustrating a desalination element with a loading mechanism comprising an inflatable fastener, and stages of loading the vertical PV with the membrane elements, according to some embodiments of the invention;

FIGS. 7A-7F are schematic block diagrams illustrating a desalination element with a loading mechanism comprising a modified cover, and stages of loading the vertical PV with the membrane elements, according to some embodiments of the invention;

FIGS. 8A-8G are schematic block diagrams illustrating a desalination element with a loading mechanism comprising a temporary support 190 (113), and stages of loading the vertical PV with the membrane elements, according to some embodiments of the invention; and

FIG. 9 is a schematic flowchart illustrating a method of loading a vertical PV with membrane elements, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the following terms in the present disclosure are defined in a non-limiting manner:

The term “pressure vessel (PV)” as used herein in this application, is defined as a closed container designed to hold liquids at a high pressure.

The term “membrane element” as used herein in this application, is defined as a mechanically supported semi-permeable membrane(s) constructed to function within a pressure vessel.

As desalination systems utilize larger and larger membrane elements, handling of single membrane elements becomes ever more cumbersome. Additionally, the membrane elements become ever more valuable and thus necessitate individual handling. Orienting the PVs vertically is a promising way to approach these challenges, and the current invention solves the problem of loading the membrane elements into the vertical PVs.

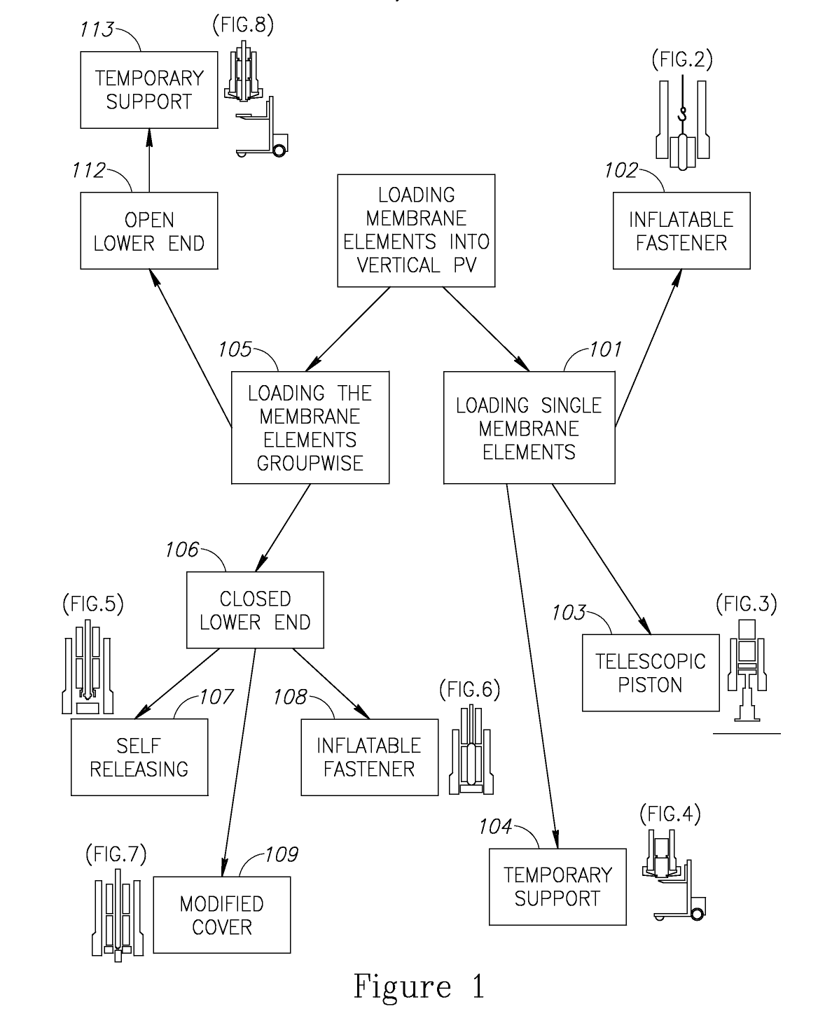

FIG. 1 is a schematic block diagram illustrating an overview of loading mechanisms 200 and loading methods for a desalination element 100 comprising a vertical PV 110, according to some embodiments of the invention.

Desalination element 100 may comprise vertical PV 110 having a vertical axis 115, an upper end 119 and a lower end 111. Desalination element 100 further comprises loading mechanism 200 arranged to allow loading membrane elements 90 (operable within vertical PV 110) into vertical PV 110. The vertical arrangement of membrane elements 90 and vertical PV 100 allows using heavy membrane elements 90 and enhances their operability.

Loading mechanism 200 may be arranged to allow loading membrane elements 90 into vertical PV 110 by defining a first end of vertical PV 110 as an insertion opening and a first membrane element 90A to be inserted; inserting membrane elements 90 into the insertion opening, beginning with first membrane element 90A such as to define a last membrane element 90Z; and covering upper end 119 with an upper cover (not shown) and lower end 111 with a lower cover 230, the covers comprising sealing means and pipe interfaces, to yield an operable desalination element 100. Lower cover 230 may comprise openings for adapter and connectors enabling the functionality of PV 110. These openings are not always illustrated, for simplicity.

Loading mechanism 200 may be arranged to load membrane elements 90 into vertical PV 110 singly and sequentially, or groupwise and interconnected. Single loading has the advantages of handling one membrane element 90 at a time (the order of handling is denoted in the following description by 90A being the first membrane element, 90B the second membrane element and 90Z the last membrane element to be loaded), yet has the disadvantage of a sequentially recurring procedure taken for each PV 110. Groupwise loading has the advantage of a single action loading, yet requires a preparation process of connecting membrane elements 90.

Membrane elements 90 may be loaded onto a covered lower end 111, i.e., with lower cover 230 in place or usable during loading, or membrane elements 90 may be loaded onto a temporary support 190, that may support membrane elements 90 during their loading, and then allow inserting lower cover 230 therethrough and removing temporary support 190 from lower end 111 of PV 110.

Some of these possibilities are illustrated in FIG. 1. Loading mechanism 200 may be arranged to load membrane elements 90 singly and sequentially (101) into vertical PV 110 or to load at least some of membrane elements 90 groupwise and interconnected (105). Loading mechanism 200 may be arranged to load all membrane elements 90 in an interconnected state at a single action into vertical PV 110. Loading membrane elements 90 groupwise (105) may be carried out before covering lower end 111, i.e., with an open lower end 111 (112) or after covering lower end 111, i.e., with a closed lower end 111 (106).

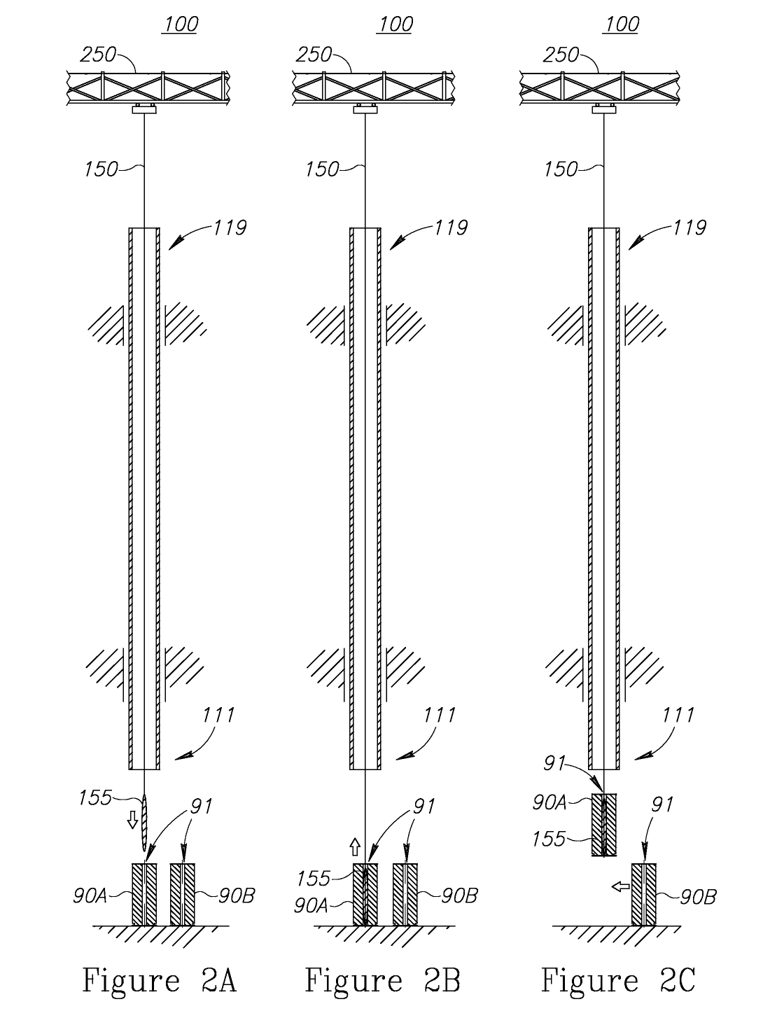

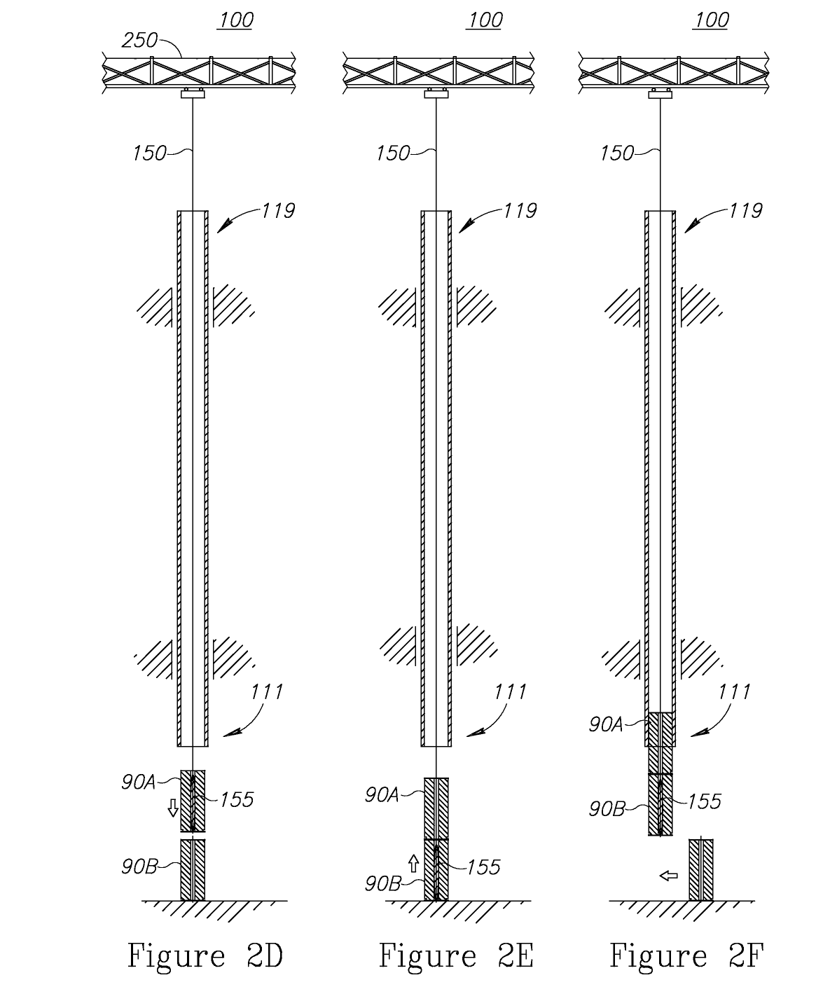

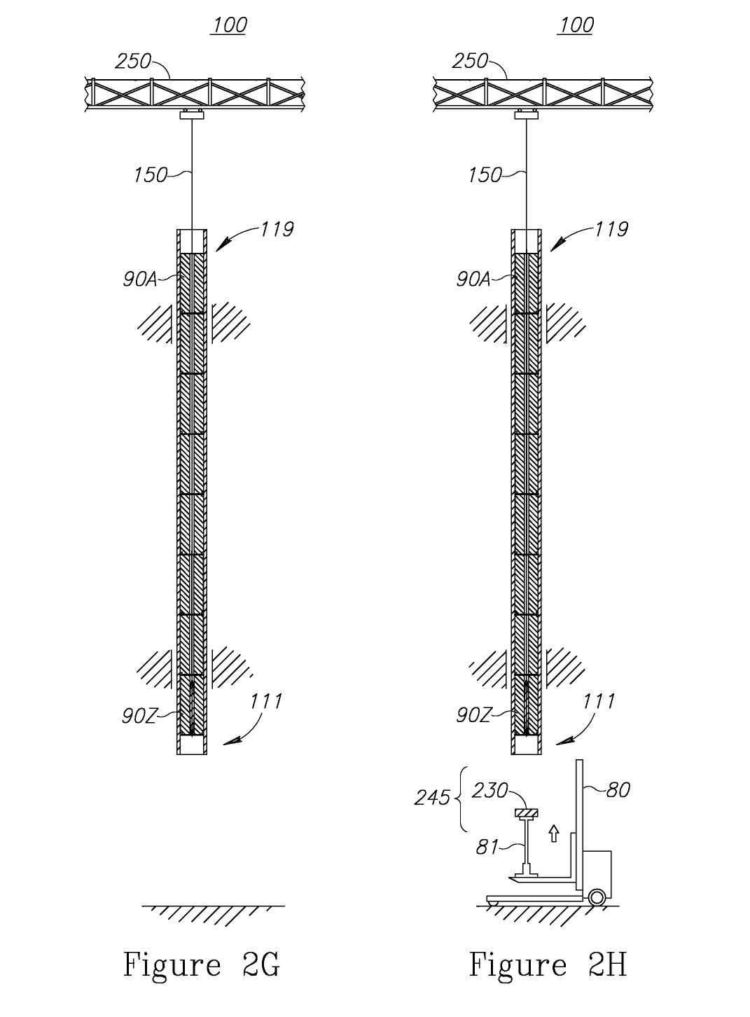

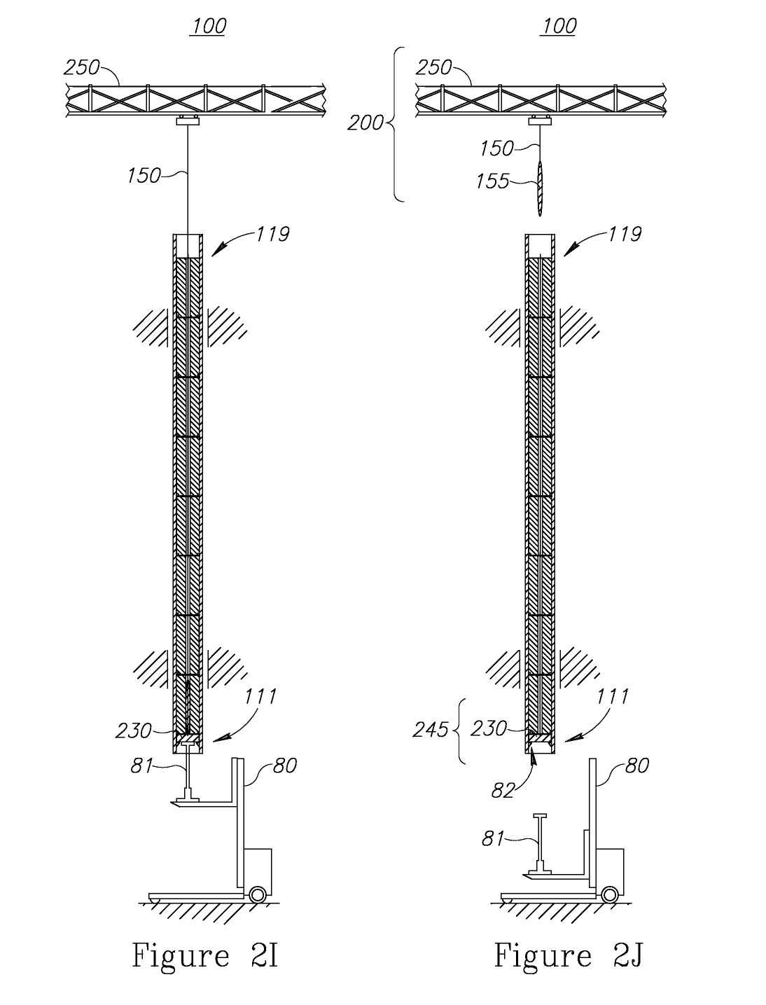

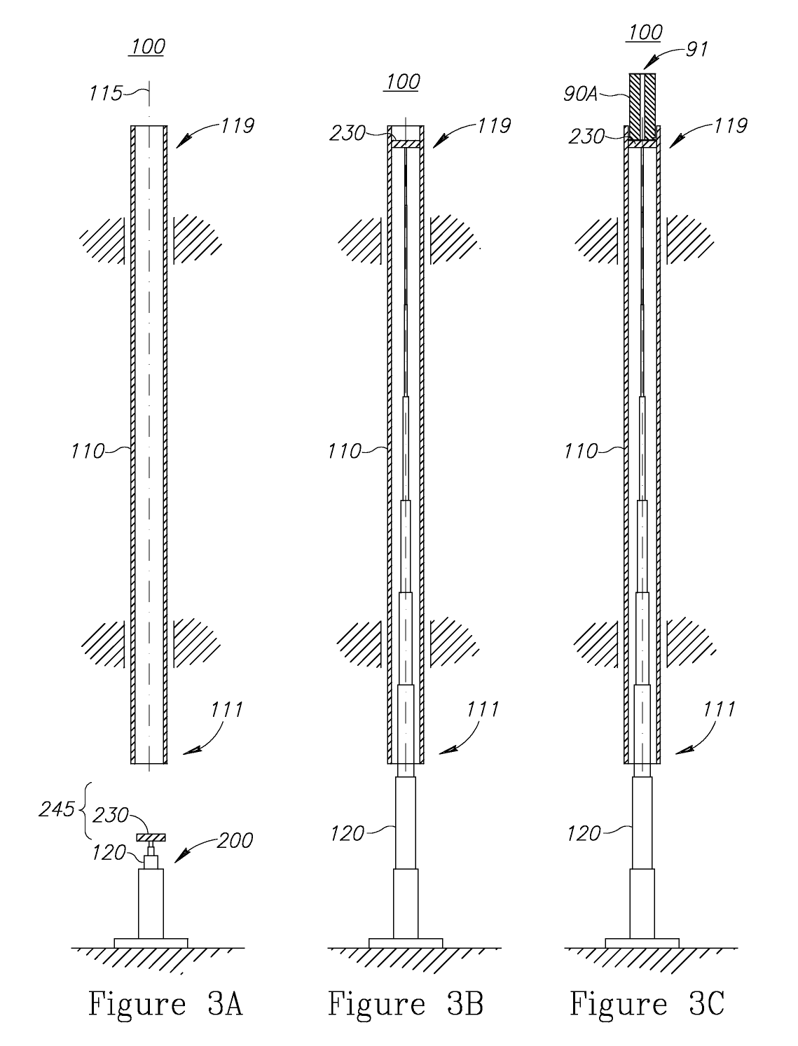

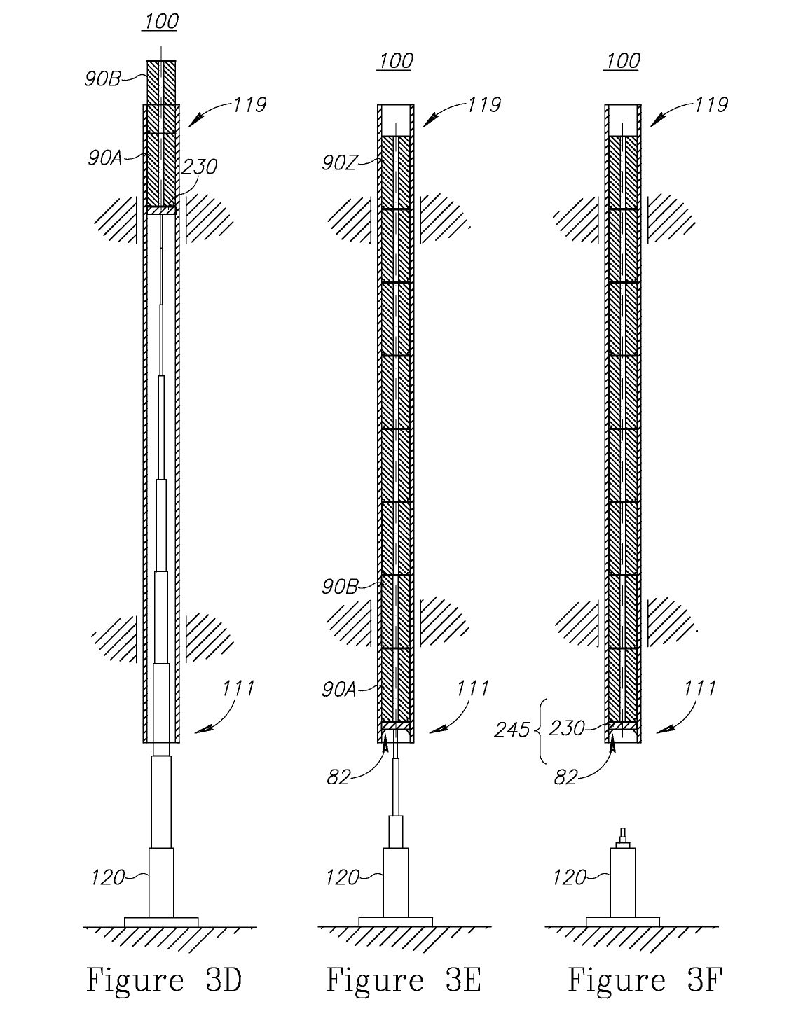

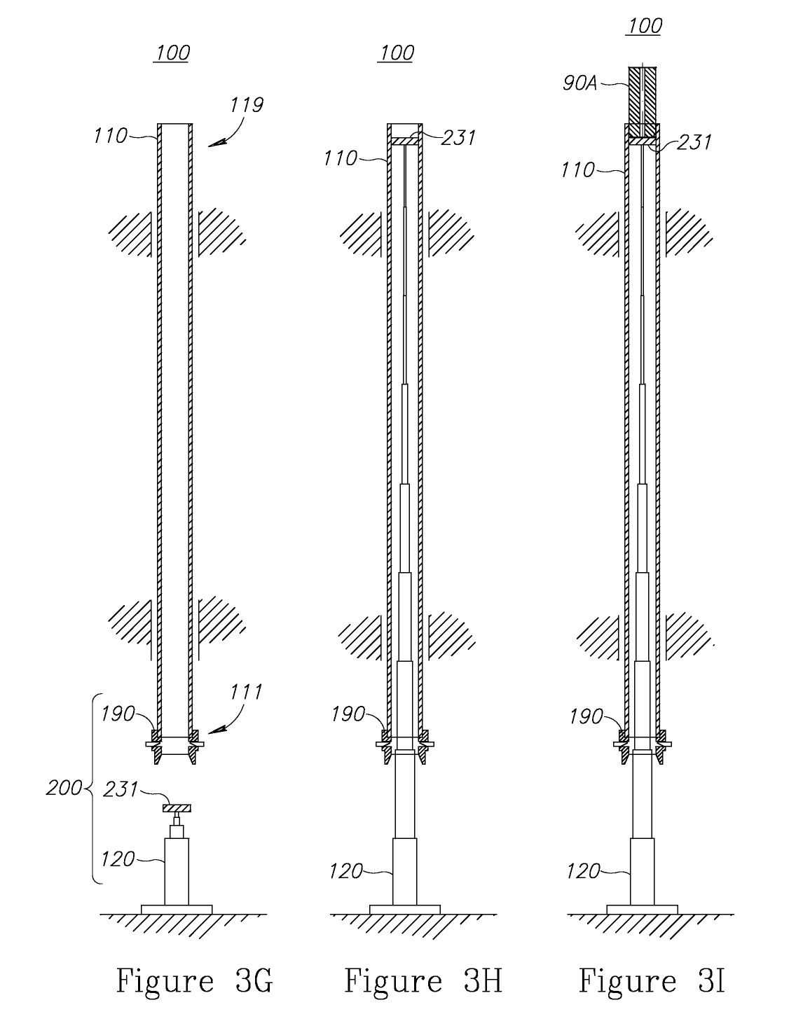

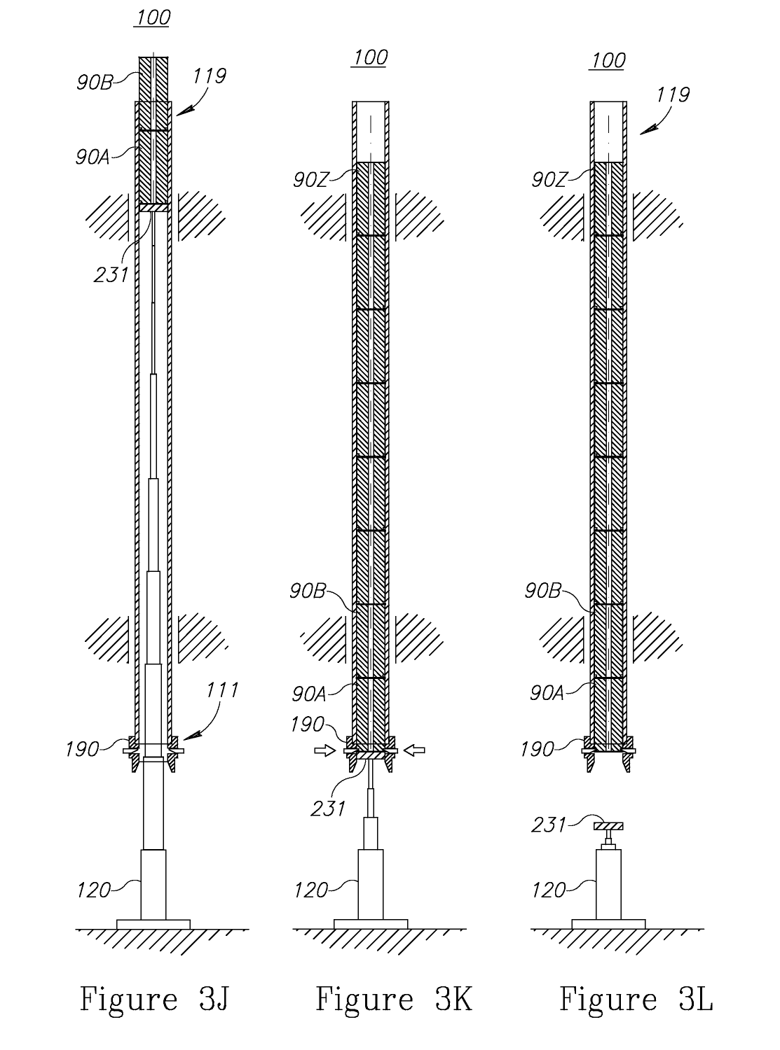

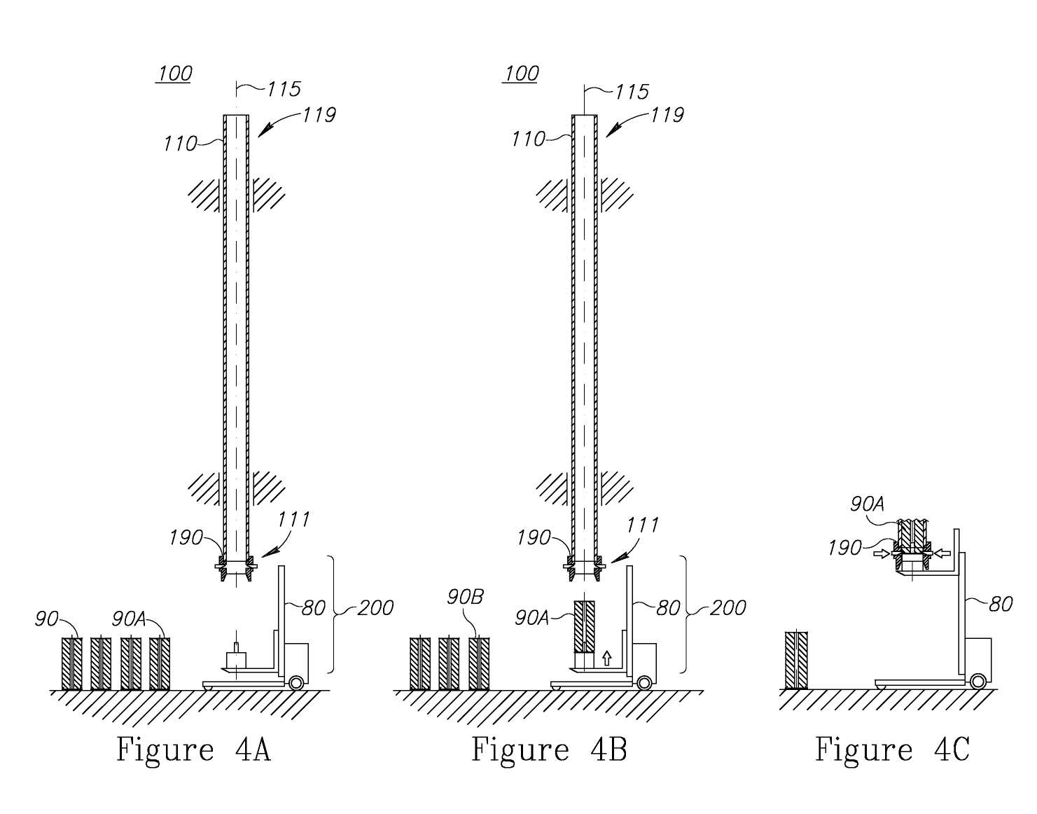

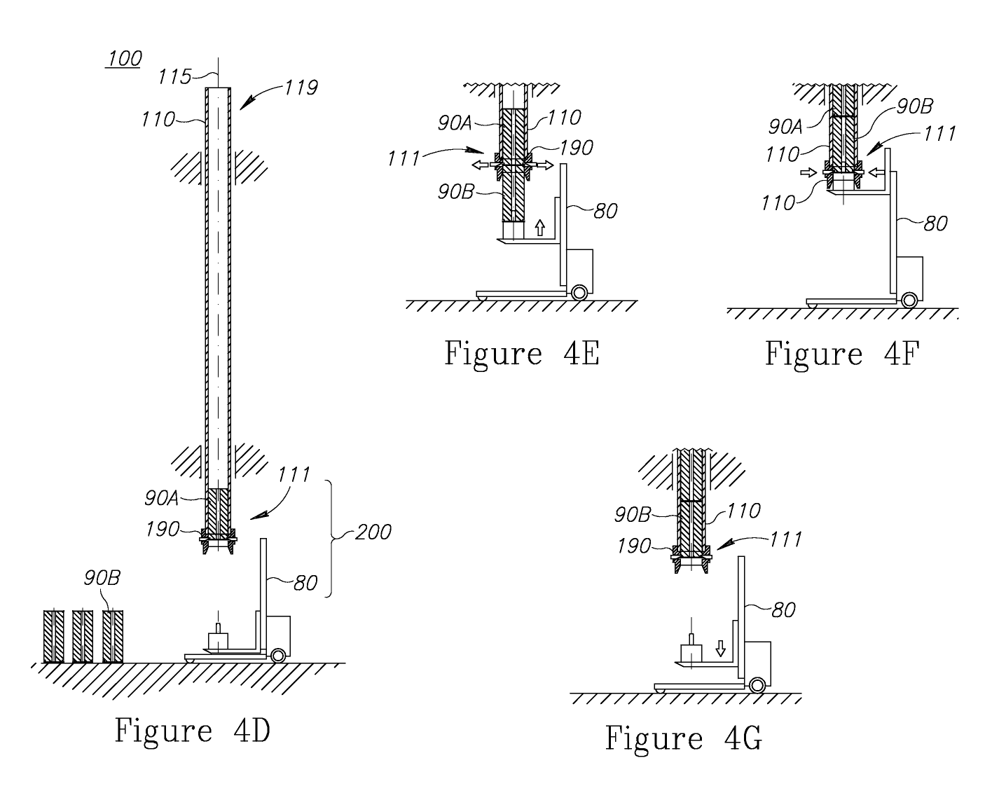

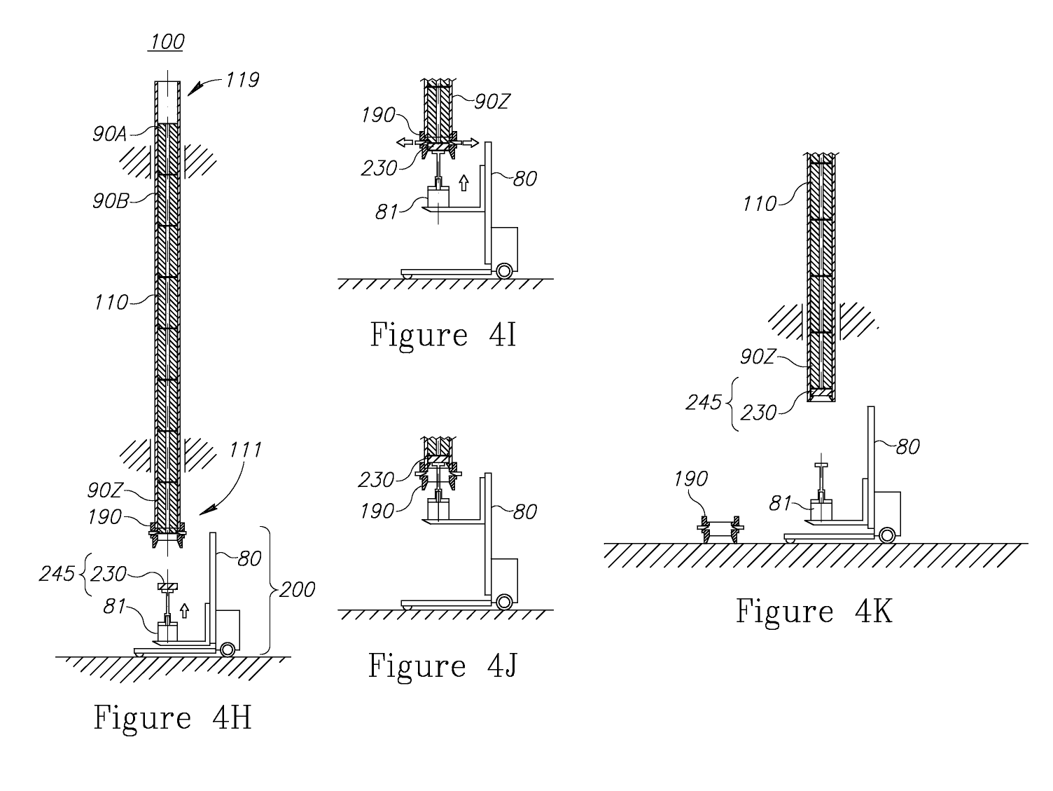

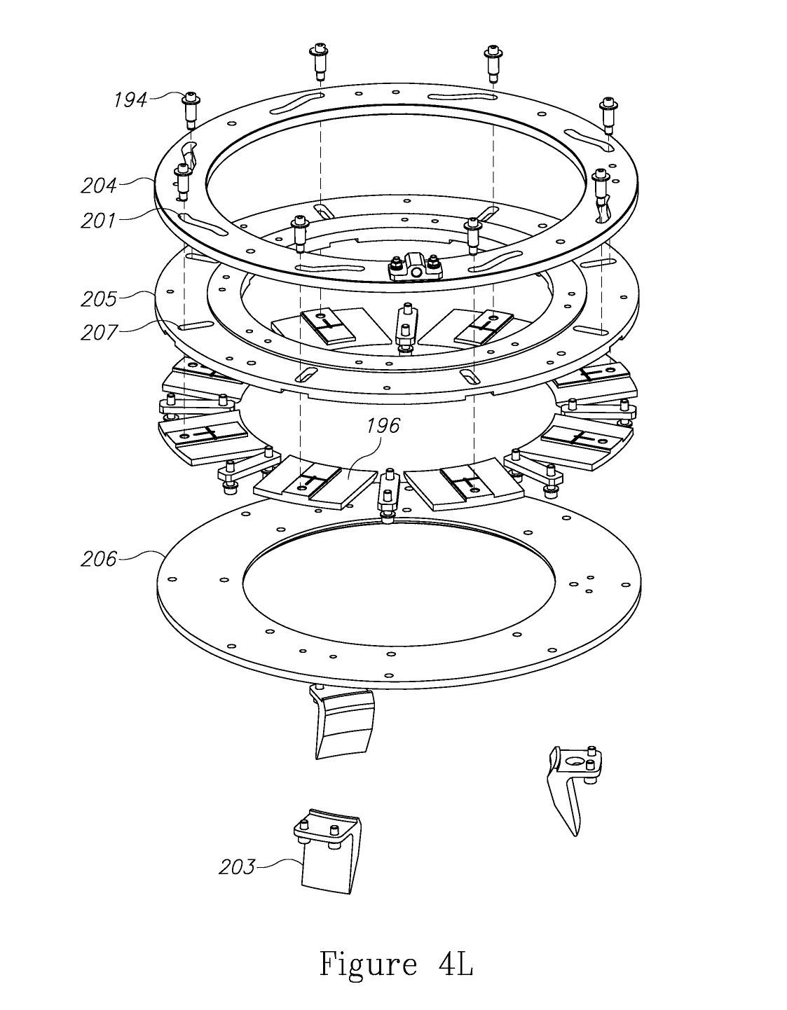

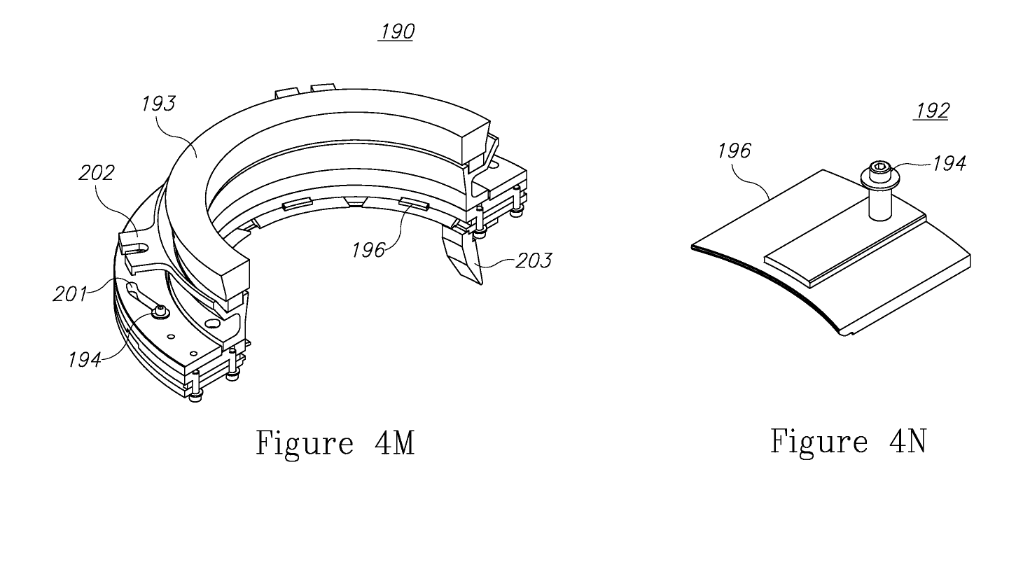

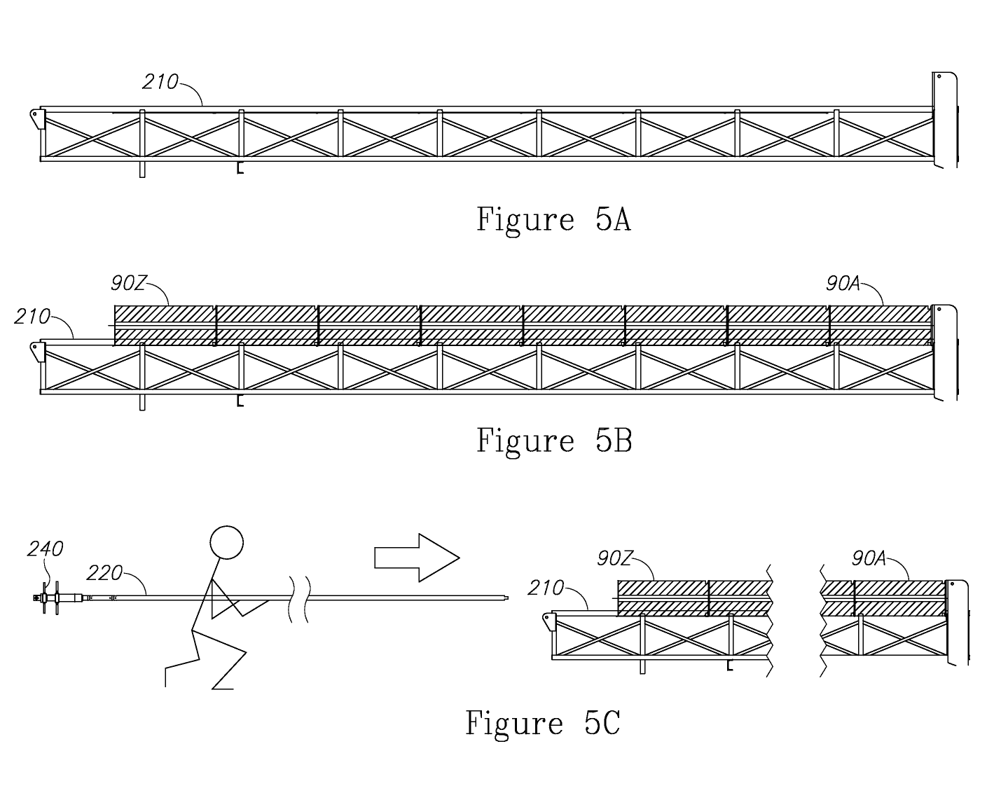

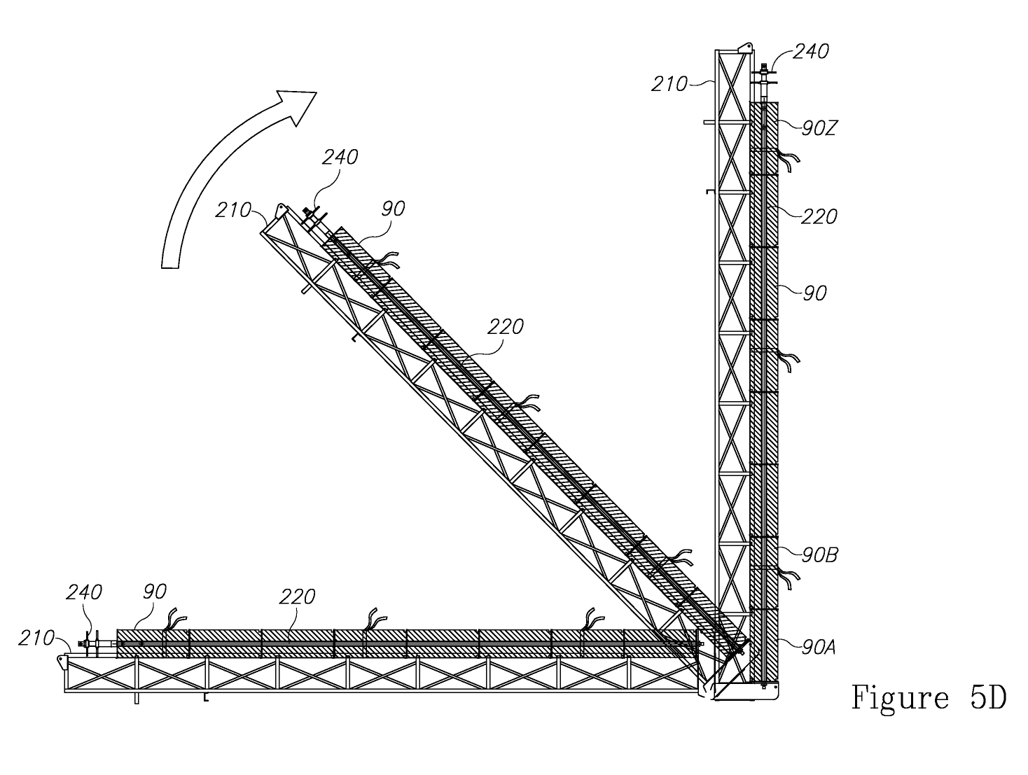

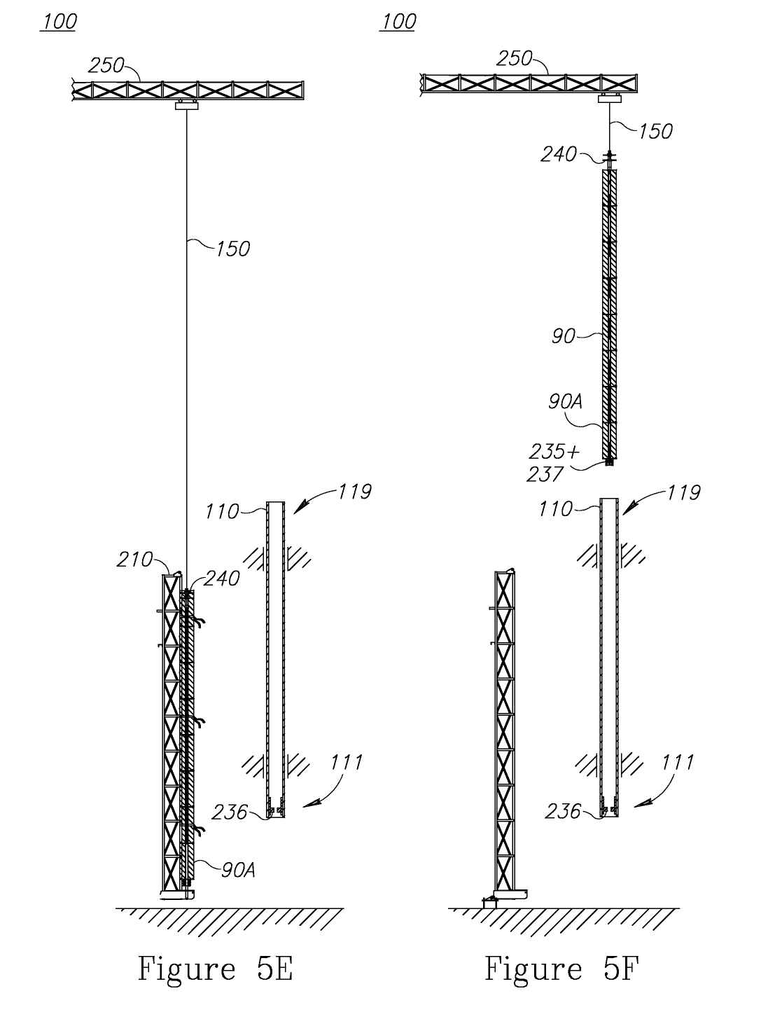

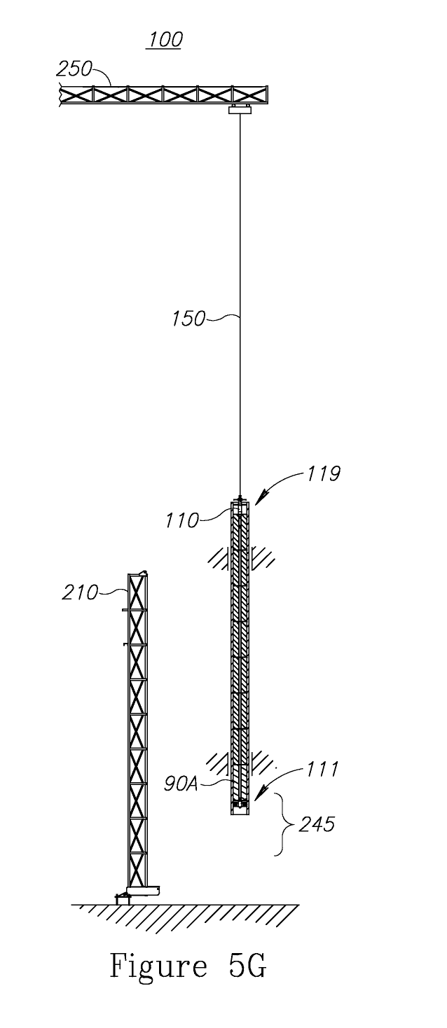

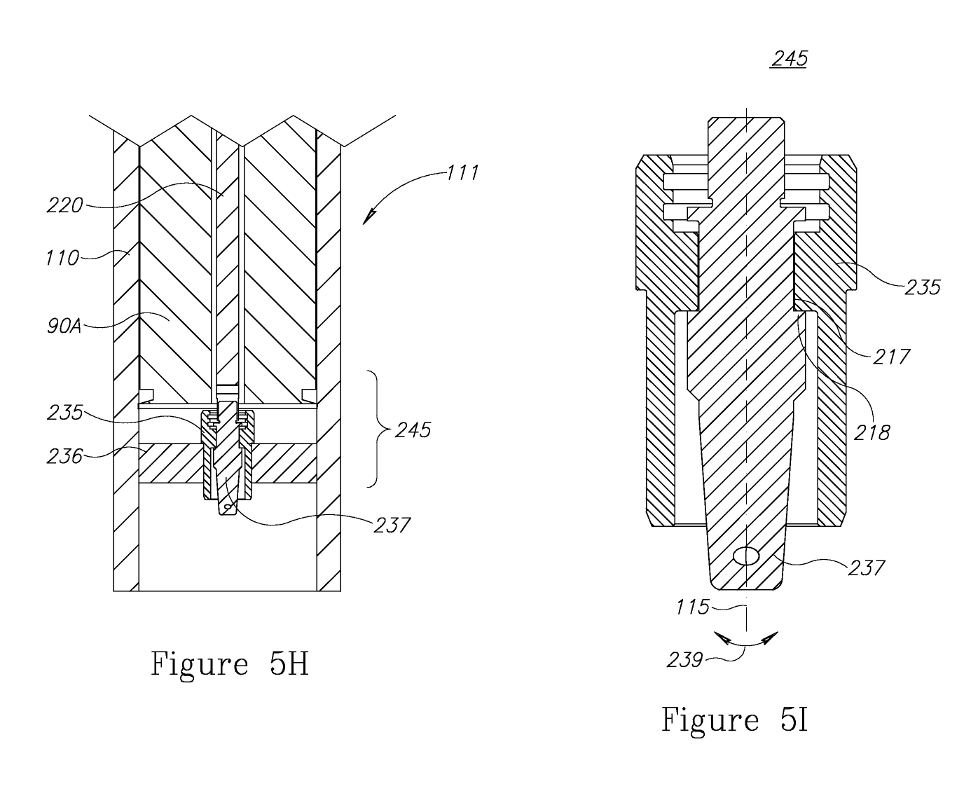

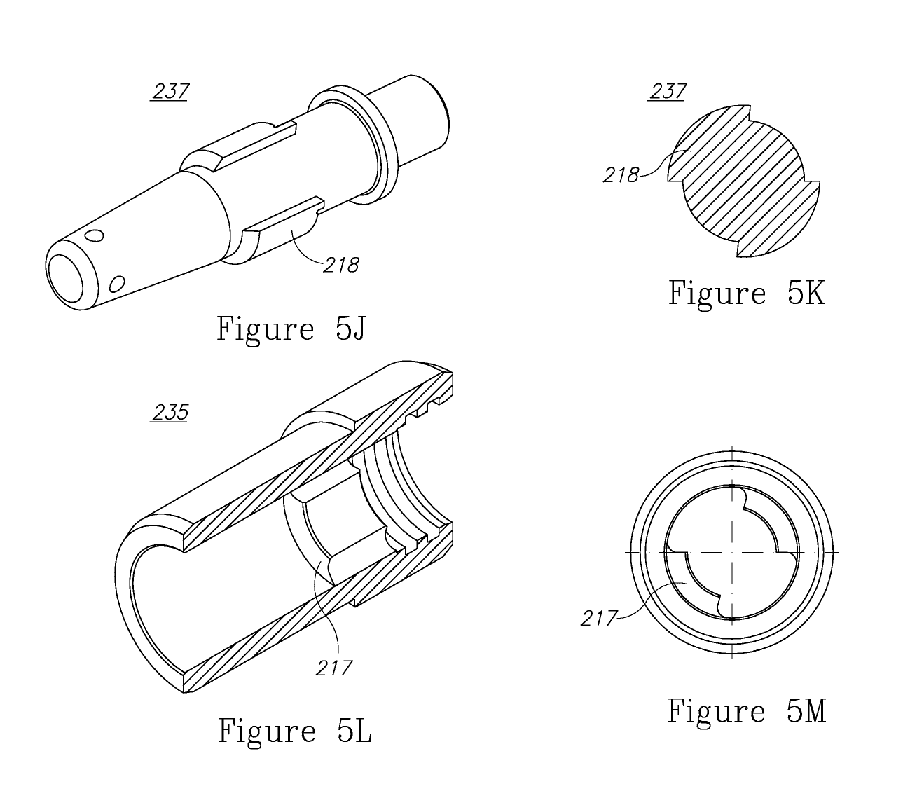

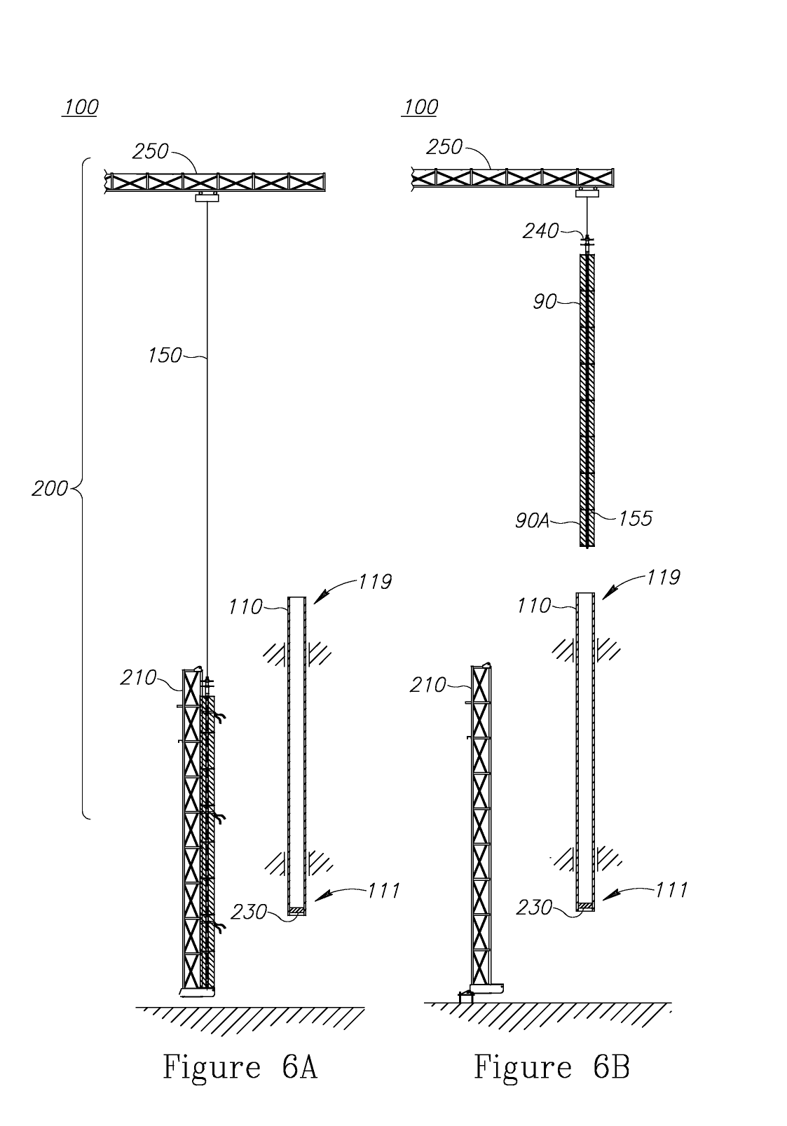

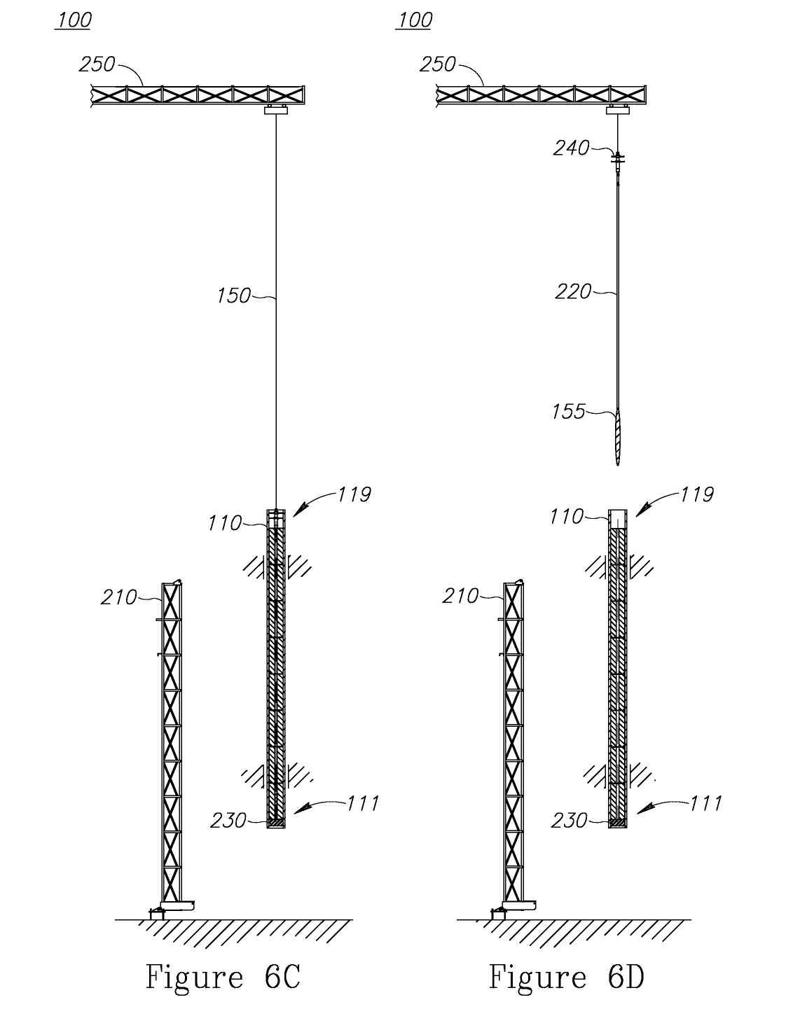

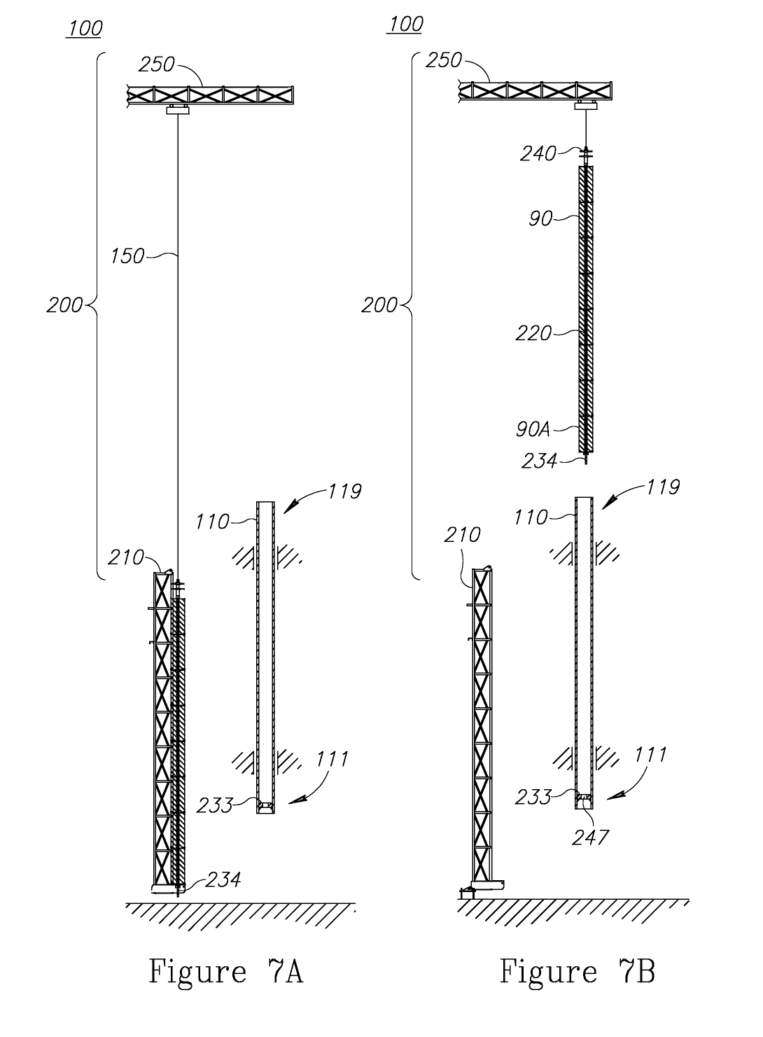

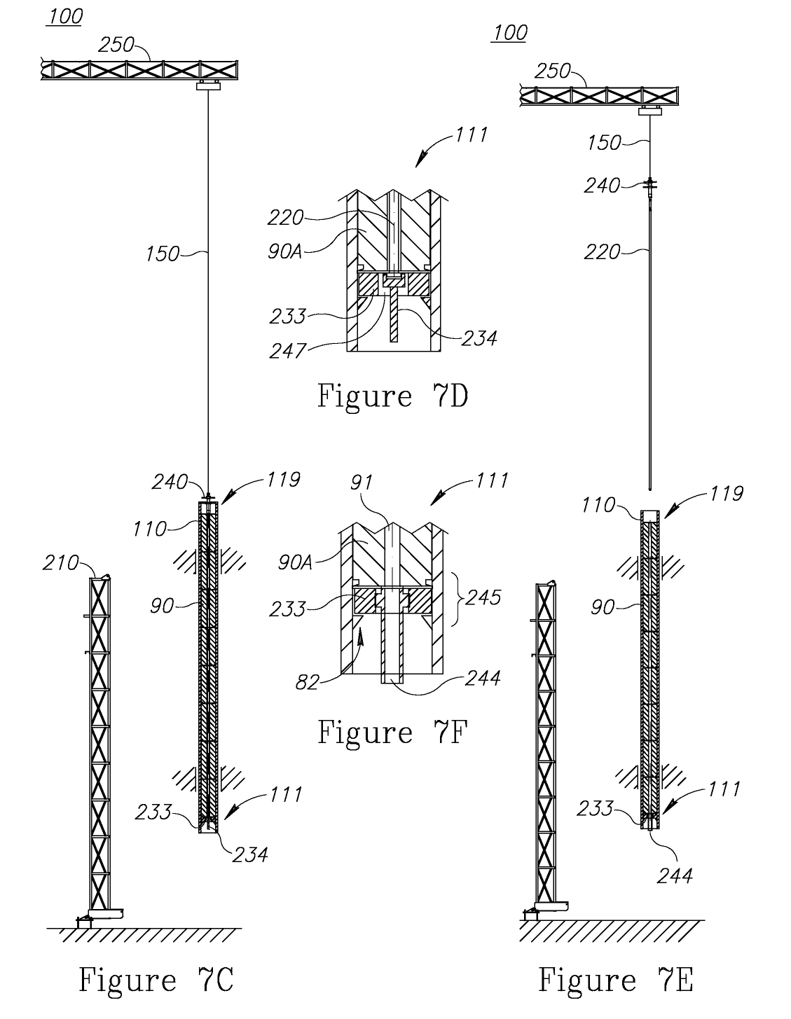

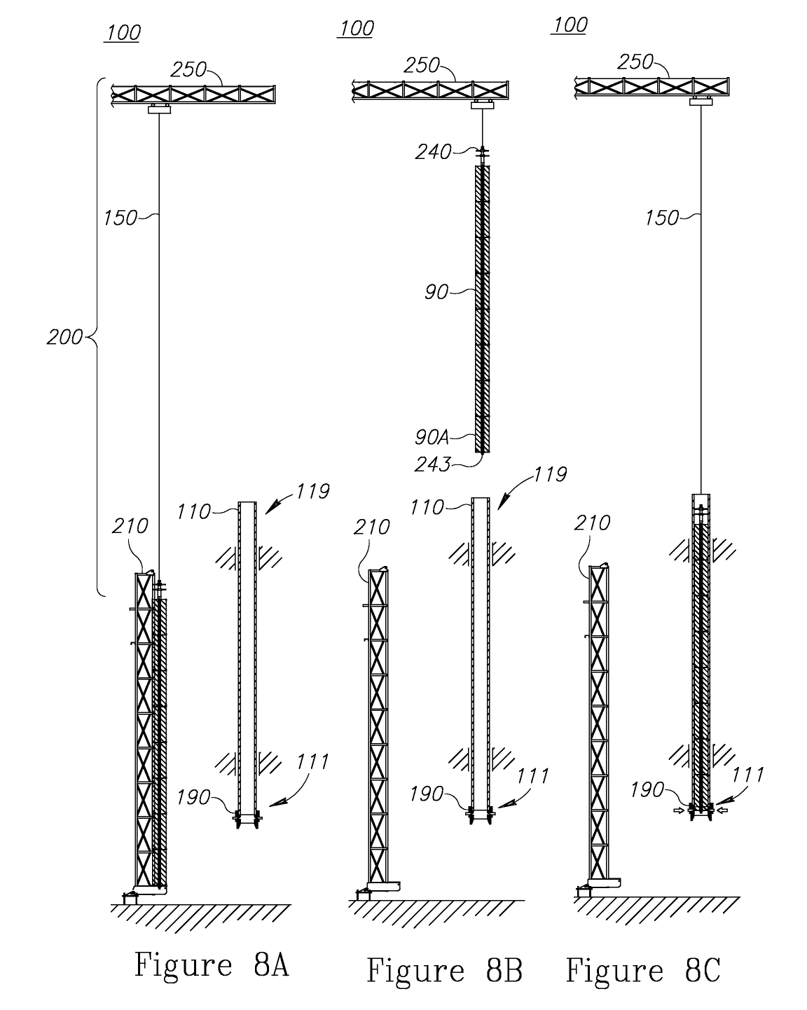

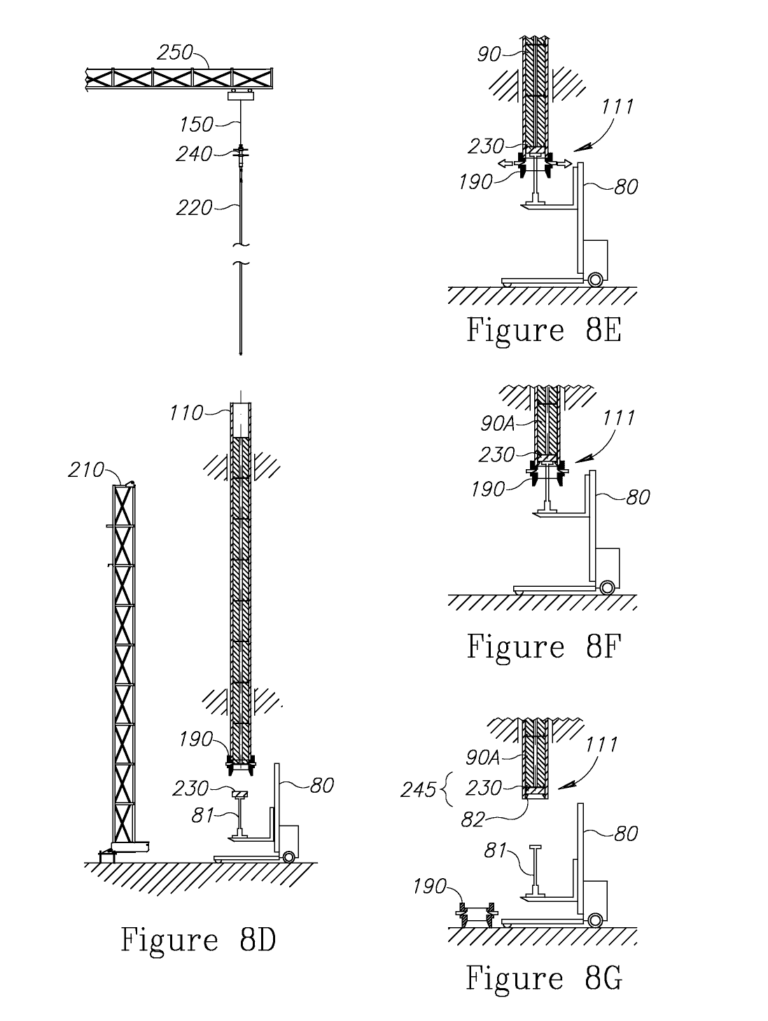

In the following diagrams, three loading methods are illustrated for loading membrane elements 90 singly and sequentially (101): using a holder 150 (102, FIGS. 2A-2J), using a telescopic piston 120 (103, FIGS. 3A-3L), and using temporary support 190 (104, FIGS. 4A-4N). Following these are diagrams illustrating four loading methods for loading membrane elements 90 groupwise and interconnected (105), the connection of membrane elements 90 illustrated in FIGS. 5A-5D: three examples with a closed lower end 111 (106), namely using a releasable fastener 237 (107, FIGS. 5A-5L), using an inflatable fastener 155 (108, FIGS. 6A-6D), and using a modified cover 233 for lower end 111 (109, FIGS. 7A-7F), and one example with an open lower end 111 (112) using temporary support 190 (113, FIGS. 8A-8G).

Loading methods 102, 104 utilize lower end 111 as the insertion opening, while loading methods 103, and the groupwise loading 107, 108, 109, 113 utilize upper end 119 as the insertion opening.

FIGS. 2A-2J are schematic block diagrams illustrating desalination element 100 with loading mechanism 200 comprising holder 150 (102) and stages of loading vertical PV 110 with membrane elements 90, according to some embodiments of the invention.

Loading mechanism 200 may comprise holder 150 positioned coaxially above vertical PV 110 and arranged to: extend through vertical PV 110 along its axis 115 (FIG. 2A) and connect to first membrane element 90A (FIG. 2B) positioned below lower end 111; sequentially contract (FIG. 2C) to pull connected membrane elements 90 through vertical PV 110, such as to allow positioning an additional membrane element 90 (FIG. 2D, illustrated is membrane element 90B) below lower end 111; set the connected membrane elements 90 upon additional membrane element 90 (FIG. 2E) and connect to additional membrane element 90 (FIG. 2F; upon reaching last membrane element 90Z (FIG. 2G), secure membrane elements 90 (FIGS. 2H and 2I), e.g. by covering lower end 111 with a lower fastener 245 such as cover 230 supported by protrusions 82, e.g. using a forklift 80 with an extender 81; and detach from last membrane element 90Z (FIG. 2J).

Holder 150 may be arranged to connect to membrane element 90 by inflating inflatable member 155 within inner conduit 91 in membrane element 90, and detach membrane element 90 by deflating inflatable member 155. Connecting to additional element 90 may be carried out after detaching from connected membrane elements 90, i.e. sequentially.

Holder 150 with inflatable member 155 may be used in the following manner to load membrane elements 90 into vertical PV 110: first membrane element 90A may be positioned below vertical PV 110 (FIG. 2A), be affixed by inflating inflatable member 155 (FIG. 2B) and heaved by holder 150 (FIG. 2C). Then, second membrane element 90B may be positioned below vertical PV 110 (FIG. 2C), first membrane element 90A may be lowered thereupon (FIG. 2D), inflatable member 155 deflated (as first membrane element 90A is supported by second membrane element 90B) and lowered (with holder 150 going through inner conduit 91 in first membrane element 90A) such as to fit into inner conduit 91 of second membrane element 90B (FIG. 2D).

Inflatable member 155 may then be inflated to affix second membrane element 90B, and holder 150 may heave first and second membrane element 90A, 90B by inflatable member 155 (FIG. 2E). These stages may then be reiterated for additional membrane elements 90 (FIG. 2F-2G), each time holder 150 lowers the former membrane elements 90 onto the positioned membrane element 90, inflatable member 155 is deflated, lowered into inner conduit 91 in the positioned membrane element 90 and inflated to affix it, and then raised with the former membrane elements 90 to allow for positioning the next membrane element 90. All membrane elements 90 per vertical PV 110 may be loaded using holder 150 at a single round, or membrane elements 90 may be loaded by holder 150 groupwise.

Inflatable member 155 may comprise a rubber balloon with attached inflating and deflating means, and may be structured and formed such as to optimally hold membrane element 90 by its inner conduit 91 without damaging or deforming membrane element 90. Inflatable member 155 may be further designed to enable supporting several membrane elements 90 upon lower membrane element 90A that is held by inflatable member 155.

FIGS. 3A-3L are schematic block diagrams illustrating desalination element 100 with loading mechanism 200 comprising using telescopic piston 120 (103) and stages of loading vertical PV 110 with membrane elements 90, according to some embodiments of the invention.

Loading mechanism 200 may comprise telescopic piston 120 positioned coaxially below vertical PV 110 (FIGS. 3A-3F—support with lower cover 230 as lower fastener 245, FIGS. 3G-3L—support with a temporary cover 231, and covering lower end 111 with lower cover 230 as in FIGS. 4H-4K) and arranged to: extend through vertical PV 110 along its axis to upper end 119 (FIGS. 3B, 3H) and connect to first membrane element 90A (FIGS. 3C, 31); stepwise contract such as to sequentially sink connected membrane elements 90 through vertical PV 110 and sequentially receive additional membrane elements 90 (FIGS. 3D-3E, FIGS. 3J-3K); secure first membrane element 90A upon reaching lower end 111 (FIGS. 3F, 3K); and detach from first membrane element 90A (FIGS. 3F, 3L). During the stepwise contraction of telescopic piston 120, each additional membrane element 90 is supported upon former membrane elements 90.

Temporary support 190 may be connected to lower end 111 and arranged to support membrane elements 90 (FIGS. 3G-3K) and allow removing temporary cover 231 and covering lower end 111 with lower cover 230 after detaching telescopic piston 120 (FIG. 3L). Advantages of using temporary cover 231 are its enhanced mobility through PV 110, and the possibility to use a standard lower cover 230.

Telescopic piston 120 may be connected to first membrane element 90A by lower cover 230, such that securing first membrane element 90A comprises the covering of lower end 111. Lower cover 230 may be configured to move through PV 110, and to allow connection to and departure from telescopic piston 120.

FIGS. 4A-4N are schematic block diagrams illustrating desalination element 100 with loading mechanism 200 comprising using temporary support 190 (104) and stages of loading vertical PV 110 with membrane elements 90, according to some embodiments of the invention.

Loading mechanism 200 may further comprise temporary support 190 (FIG. 4A, 4B) arranged to be removably connected to lower end 111, support loaded membrane elements 90 (FIGS. 4C-4G), and allow connecting lower cover 230 as lower fastener 245 to lower end 111 (FIGS. 4H-4J), to replace temporary support 190 (FIG. 4K). Lower cover 230 may be connected to PV 110 using extender 81 and forklift 80. Lower cover 230 may be supported on protrusions 82 to allow removing temporary support 190.

Loading mechanism 200 may be arranged to load membrane elements 90 into vertical PV 110 singly and sequentially through lower end (FIGS. 4A-4K), by sequentially pushing additional membrane element 90 through temporary support 190 such as to raise formerly loaded membrane elements 90, and supporting inserted membrane elements 90 by temporary support 190.

FIGS. 4L-4N are schematic illustrations of temporary support 190, according to some embodiments of the invention. FIG. 4L is an exploded view, FIG. 4M is a perspective view of a cross section through temporary support 190, and FIG. 4N is a perspective view of retractable holder 192.

Temporary support 190 may comprise retractable holders 192, with a retraction mechanism as illustrated in FIG. 4L-4N. Each retractable holder 192 comprises two interconnected parts—a positioning pin 194 and a protrusion 196. The two parts structure allows effective retraction of protrusions 196 into the limited volume of temporary support 190.

Multiple retractable holders 192 may be held within a frame comprising an upper basis 193, a lower basis 206 with supporting elements 203 attached thereupon. The movement of retractable holders 192 may be achieved by an upper plate 204 and a lower plate 205 having guiding slits in which positioning pins 194 may move. Guiding slits 207 in lower plate 205 are radial and permit a radial movement of positioning pins 194 (and of retractable holders 192). Guiding slits 201 in upper plate 204 are diagonal and permit a diagonal movement, i.e. having a radial and a tangential component, of positioning pins 194 (and of retractable holders 192). Upper plate 204 is moveable, and is arranged to allow external control of the positions of retractable holders 192. In this way, turning upper plate 204 allows inserting membrane elements and supporting loaded membrane elements (e.g. as illustrated in FIGS. 4E and 4F).

A permanent lower cover 230 as lower fastener 245 may be inserted through temporary support 190 in a similar manner to the loading of membrane elements 90, and be fixated into indentations or grooves in lower end 111. Temporary support 190 may be permanently connected or part of lower end 111 of vertical PV 110. Alternatively, after connecting permanent cover 195, retractable holder 190 may be removed and used on other vertical PVs 110.

FIGS. 5A-5D are schematic block diagrams illustrating the interconnection of membrane elements 90, according to some embodiments of the invention. According to some embodiments, membrane elements 90 may be interconnectable, and loading mechanism 200 may be arranged to load at least some of membrane elements 90 into vertical PV 110 groupwise and interconnected.

Loading mechanism 200 may comprise a horizontal frame 210 (FIG. 5A) arranged to support a plurality of interconnected membrane elements 90 (FIG. 5B); a shaft 220 arranged to go through (FIG. 5C) and affix interconnected membrane elements 90 and connect to a lower fastener 245 being either lower cover 230, a part of lower cover 230 or an additional part, as described in the following, and to an upper connector 240. Horizontal frame 210 may be erected to a vertical orientation (FIG. 5D) to bring interconnected membrane elements to an insertable position.

Loading mechanism 200 may further comprise a crane 250 arranged to heave interconnected membrane elements 90 by upper connector 240 (FIGS. 5E and 5F), and to insert interconnected membrane elements 90 through upper end 119 of vertical PV 110 (FIG. 5G). Lower fastener 245 may be arranged to fasten membranes 90 at lower end 111 of vertical PV 110 and to disconnect from shaft 220 upon a rotation (239) of upper connector 119, possibly simultaneously with fastening upper membrane element to upper end 119 of vertical PV 110. Lower fastener 245 may comprise a part of lower cover 230 and may be arranged to disconnect from shaft 220 upon a rotation of upper connector 240 (see FIGS. 5I-5M).

Interconnected membrane elements 90 may be fastened to horizontal frame 210 during or after their connecting. Interconnected membrane elements 90 may unfastened from horizontal frame 210 and then be lifted by crane 250 from horizontal frame 210, or crane 250 may lift horizontal frame 210 with interconnected membrane elements 90 to a vertical position and then interconnected membrane elements 90 may be unfastened from horizontal frame 210. Alternatively, horizontal frame 210 with interconnected membrane elements 90 may be brought to a vertical position by means other than crane 250, then crane 250 may be connected to upper connector 240, interconnected membrane elements 90 released from frame 210 and inserted into vertical PV 110.

FIGS. 5E-5H are schematic block diagrams illustrating desalination element 100 with loading mechanism 200 comprising releasable fastener 237 (107), and stages of loading vertical PV 110 with membrane elements 90, according to some embodiments of the invention. FIGS. 5I-5M are schematic illustrations of releasable fastener 237, according to some embodiments of the invention.

Lower cover 230 may comprise two parts: a first part 236 designed to close PV 110 and to support membrane elements 90, and a second part 235 connectable to first part 236 and designed as an adapter for connecting pipes to PV 110 (FIGS. 5I-5M). Second part 235 may be arranged to sealably connect to first part 236 when set thereupon from above (from inside PV 110). Second part 235 further support membrane elements 90 during insertion as described below. After releasing releasable fastener 237, first part 236 with second part 235 are left as (modified) lower cover 230 at lower end 111 of PV 110.

Second part 235 may be arranged to temporarily connect to releasable fastener 237. Second part 235 together with releasable fastener 237 may be connected to shaft 220 as lower fastener 245 (FIGS. 5H, 5I) and inserted with membrane elements 90 into PV 110 and onto lower cover 230, or modified lower cover 233. The insertion may be carried out such as to position second part 235 in a correct operational connection with first part 236.

Second part 235 and releasable fastener 237 may be configured to allow releasing releasable fastener 237 from second part 235, and releasable fastener 237 may be designed to allow its removal through conduit 91 with shaft 220 from PV 110. While operating together as lower fastener 245, second part 235 and releasable fastener 237 may support membrane elements 90, wherein the actual load of the membrane elements is sustained by second part 235, and releasable fastener 237 connects second part 235 to shaft 220.

Second part 235 and releasable fastener 237 may be shaped to allow disconnection upon rotation 239 of shaft 220. For example, releasable fastener 237 may engage second part 235 with protrusions 218 of releasable fastener 237 fitting into notches 217 in second part 235. Protrusions 218 and notches 217 may cover only a part of the perimeter of second part 235 and of releasable fastener 237, such as to allow release of releasable fastener 237 by rotational movement 239 applied to shaft 220 to which it is connected. Second part 235 stays in place and operates as an adaptor, while releasable fastener 237 is removed with shaft 220.

FIGS. 6A-6D are schematic block diagrams illustrating desalination element 100 with loading mechanism 200 comprising inflatable member 155 (108) and stages of loading vertical PV 110 with membrane elements 90, according to some embodiments of the invention.

Lower fastener 245 may comprise inflatable member 155 connected to holder 150 and arranged to connect to or affix interconnected membrane elements 90 by inflation within inner conduit 91 in at least one of interconnected membrane elements 90 (FIG. 6A), and to detach from interconnected membrane elements 90 by deflation (FIG. 6D). Inflation of inflatable member 155 exerts high pressure to the sides of conduit 91, affixes membrane element 90 and allows heaving interconnected membrane elements 90.

Inflatable member 155 may be connected to holder 150 and/or to shaft 220 and used to position interconnected membrane elements 90 onto the permanent lower cover 230 (FIGS. 6B-6C) and easily remove shaft 220 (FIG. 6D).

FIGS. 7A-7F are schematic block diagrams illustrating desalination element 100 with loading mechanism 200 comprising modified cover 233 (109), and stages of loading vertical PV 110 with membrane elements 90, according to some embodiments of the invention;

Lower fastener 245 may be the permanent lower cover 230 of lower end 111, or temporarily hold the lower membrane element 90 until the grouped membrane elements 90 are set into vertical PV 110. In the temporary version, membrane elements 90 may be inserted into vertical PV 110 with a covered lower end 111, and lower cover 230 may be configured to release the lower membrane element 90, e.g. by turning or by mechanical or electric activation from the upper end of shaft 220, to allow withdrawal of shaft 220 without lower cover 230 after setting membrane elements 90 thereupon.

Lower fastener 245 may comprise an extended nut 234 configured to go through an opening 247 in lower cover 230, or in a modified lower cover 233 (FIGS. 7A-7D) and allow connecting interconnected membrane elements 90 to shaft 220. After setting membrane elements 90 upon modified lower cover 233 (supported e.g. by protrusions 82), extended nut 234 may be removed to release shaft 220. Then a sealing and piping adapter 244 may be connected to either lower cover 230 or modified lower cover 233.

Interconnected membrane elements 90 may be lifted by crane 250 (FIGS. 7A-7B), inserted into vertical PV 110 (FIG. 7C) such that they are connected to extended nut 234 and set upon modified lower cover 233 which is placed at lower end 111. Nut 234 is then released externally, shaft 220 is removed, and adapter 244 is connected to modified lower cover 233 externally. Modified lower cover 233 may be arranged to be connected to lower end 111 (FIG. 7A) before loading membrane elements 90, support loaded membrane elements 90 (FIG. 7C), and allow removing lower fastener 245 (e.g. extended nut 234) therethrough (FIG. 7D), and adapter 244 may be arranged to be connected to modified lower cover 233 after removal of lower fastener 245 (FIG. 7F), to yield an operable desalination element 100.

Lower cover 230 may be a modified lower cover 233 having an opening 247 larger than the opening in lower cover 230, and an adapter 244 that may be connected to opening 247 to provide an interface with external product water pipes (FIG. 7F). Adapter 244 is externally connectable and removable from modified lower cover 233. Shaft 220 is inserted through interconnected membrane elements 90 and through opening 247, and is fastened to modified lower cover 233 (without adapter 244) by extended nut 234 externally, i.e. on the side opposing membrane elements 90.

FIGS. 8A-8G are schematic block diagrams illustrating desalination element 100 with loading mechanism 200 comprising temporary support 190 (113), and stages of loading vertical PV 110 with membrane elements 90, according to some embodiments of the invention;

Temporary support 190 may be arranged to be removably connected to lower end 111, support loaded membrane elements 90, and allow connecting lower cover 230 to lower end 111, to replace temporary support 190.

Lower fastener 245 may be a nut 243, and interconnected membrane elements 90 may be inserted into vertical PV 110 by crane 250 (FIGS. 8A-8C) and supported on retractable holder 190 (FIG. 8C) with an opening 246 that allows releasing nut 243 externally and removal of shaft 220.

Temporary support 190 may comprise retractable holders 192, with a retraction mechanism as illustrated in FIG. 4L-4N. Each retractable holder 192 comprises two interconnected parts—a positioning pin 194 and a protrusion 196. The two parts structure allows effective retraction of protrusions 196 into the limited volume of temporary support 190.

Multiple retractable holders 192 may be held within a frame comprising an upper basis 193, a lower basis 206 with supporting elements 203 attached thereupon. The movement of retractable holders 192 may be achieved by an upper plate 204 and a lower plate 205 having guiding slits in which positioning pins 194 may move. Guiding slits 207 in lower plate 205 are radial and permit a radial movement of positioning pins 194 (and of retractable holders 192). Guiding slits 201 in upper plate 204 are diagonal and permit a diagonal movement, i.e. having a radial and a tangential component, of positioning pins 194 (and of retractable holders 192). Upper plate 204 is moveable, and is arranged to allow external control of the positions of retractable holders 192. In this way, turning upper plate 204 allows inserting membrane elements and supporting loaded membrane elements (e.g. as illustrated in FIGS. 4E and 4F).

A permanent lower cover 230 may be inserted through temporary support 190 in a similar manner to the loading of membrane elements 90, and be fixated into indentations or grooves in lower end 111. Temporary support 190 may be permanently connected or part of lower end 111 of vertical PV 110. Alternatively, after connecting permanent cover 195, retractable holder 190 may be removed and used on other vertical PVs 110.

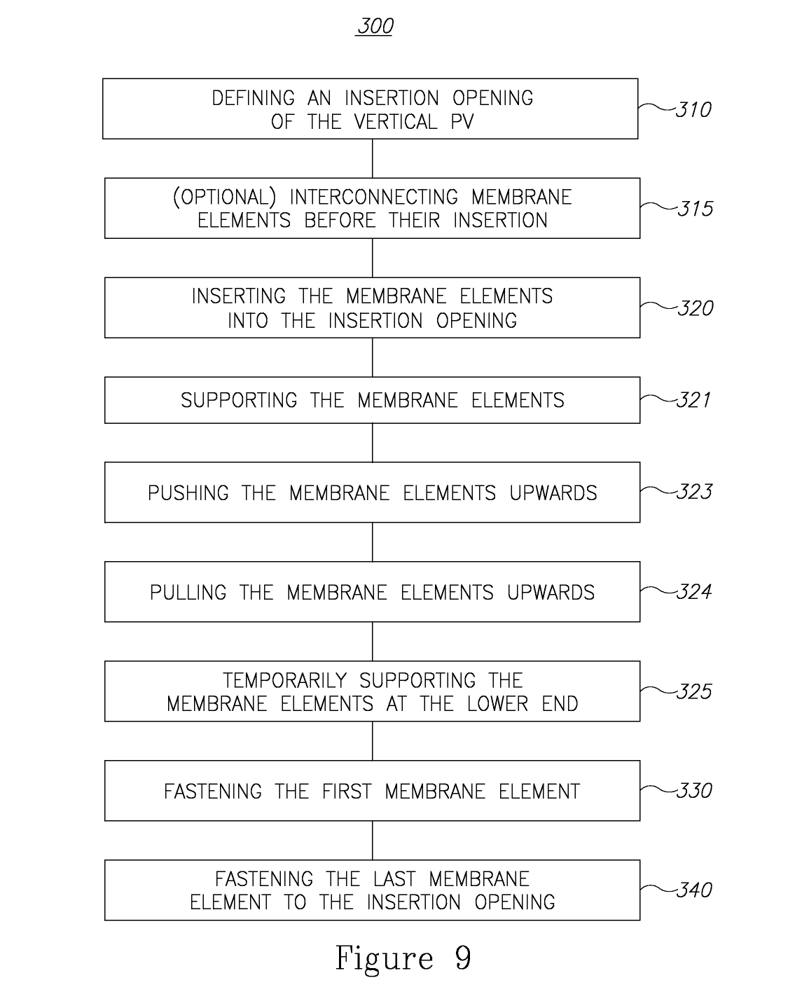

FIG. 9 is a schematic flowchart illustrating a method 300 of loading a vertical PV with membrane elements, according to some embodiments of the invention. Method 300 comprises the following stages: defining a first end of the vertical PV as an insertion opening and a first membrane element to be inserted (stage 310); inserting the membrane elements into the insertion opening, beginning with the first membrane element such as to define a last membrane element (stage 320); fastening the first membrane element at a second end of the vertical PV that is opposite to the first end (stage 330); and fastening the last membrane element to the insertion opening (stage 340). The vertical arrangement of the membrane elements and the vertical PV enhances air bubble percolation, increases construction efficiency and allows handling heavy membrane elements.

The first end may be an upper end of the vertical PV, and the second end may be a lower end of the vertical PV. The membrane elements may be inserted into the insertion opening (stage 320) singly and sequentially. The membrane elements may be supported (stage 321) on their downwards insertion by a device extending through the lower end and through the vertical PV or by a device extending through the upper end and through the vertical PV.

Method 300 may further comprise interconnecting at least some of the membrane elements before their insertion (stage 315), such that the membrane elements are inserted (stage 320) groupwise.

The first end may be a lower end of the vertical PV, and the second end may be an upper end of the vertical PV. The membrane elements may be inserted into the insertion opening (stage 320) singly and sequentially.

The membrane elements may be pushed upwards by a device extending through the lower end and through the vertical PV (stage 323).

The membrane elements may be pulled upwards by a device extending through the upper end and through the vertical PV (stage 324).

The membrane elements may be pushed upwards and temporarily supported at the lower end (stage 325).

Supporting the membrane elements (stage 321) may be carried out by connecting an accessorial appliance to the first membrane element either externally or internally at a cavity in the first membrane element.

Advantageously, the columnar arrangement of membrane elements 90 in vertical PVs 110 generates loads on membrane elements 90 which result in: (i) a limitation of the movement of membrane elements 90 upon changes in a flow of the feed water, as during initiation and stopping of the desalination process, (ii) a tolerance to thermal expansion and contraction of membrane elements 90, (iii) both (i) and (ii) allow disposing of the need to apply and replace spacers between membrane elements 90 (shimming) and avoid damage to sealing elements associated with membrane elements 90; and (iv) an efficient and full evacuation of foam produced during cleaning membrane elements 90, which may otherwise damage membrane elements 90 or require long time to evacuate.

The loading methods 300 and mechanisms 200 presented here allow to use heavy membrane elements 90 to benefit from these advantages, and further enhance their operability by generating the ability to replace individual membrane elements 90 that are find defective. It is only with the disclosed loading mechanisms 200 that handling large membrane elements 90 in an industrially acceptable scale becomes feasible.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A desalination element comprising:
a vertical pressure vessel (PV) having a vertical axis, an upper end and a lower end; a plurality of membrane elements operable within the vertical PV in a single column; and
a loading mechanism arranged to allow loading the membrane elements into the vertical PV by defining a first end of the vertical PV as an insertion opening and a first membrane element to be inserted; inserting the membrane elements into the insertion opening, beginning with the first membrane element such as to define a last membrane element; and covering the upper end with an upper cover and the lower end with a lower cover, the covers comprising sealing means and pipe interfaces, to yield an operable desalination element.

2. The desalination element of claim 1, wherein the loading mechanism is arranged to load the membrane elements into the vertical PV singly and sequentially.

3. The desalination element of claim 2, wherein the loading mechanism comprises a holder positioned coaxially above the vertical PV and arranged to:
extend through the vertical PV along its axis and connect to the first membrane element positioned below the lower end;
sequentially contract to pull connected membrane elements through the vertical PV, such as to allow positioning an additional membrane element below the lower end;
set the connected membrane elements upon the additional membrane element and connect to the additional membrane element;
upon reaching the last membrane element, secure the membrane elements; and detach from the last membrane element.

4. The desalination element of claim 3, wherein the holder is arranged to connect to the membrane element by inflating an inflatable member within an inner conduit in the membrane element, and detach the membrane element by deflating the inflatable member, and wherein connecting to the additional element is carried out after detaching from the connected membrane elements.

5-7. (canceled)

8. The desalination element of claim 1, wherein the loading mechanism further comprises a temporary support arranged to be removably connected to the lower end, support the loaded membrane elements, and allow connecting the lower cover to the lower end, to replace the temporary support.

9. The desalination element of claim 8, wherein the loading mechanism is arranged to load the membrane elements into the vertical PV singly and sequentially through the lower end, by sequentially pushing an additional membrane element through the temporary support such as to raise formerly loaded membrane elements, and supporting the inserted membrane elements by the temporary support.

10. The desalination element of claim 1, wherein the membrane elements are interconnectable, and wherein the loading mechanism is arranged to load at least some of the membrane elements into the vertical PV groupwise and interconnected.

11. (canceled)

12. The desalination element of claim 10, wherein the loading mechanism comprises: a horizontal frame arranged to support a plurality of interconnected membrane elements;
a shaft arranged to go through and affix the interconnected membrane elements, the shaft connected to a lower fastener and to an upper connector; and
a crane arranged to heave the interconnected membrane elements by the upper connector, and to insert the interconnected membrane elements through the upper end of the vertical PV.

13-14. (canceled)

15. The desalination element of claim 12, wherein the lower fastener comprises an inflatable member arranged to connect to the interconnected membrane elements by inflation within an inner conduit in at least one of the interconnected membrane elements, and to detach from the interconnected membrane elements by deflation.

16. (canceled)

17. The desalination element of claim 10, wherein the loading mechanism further comprises a temporary support arranged to be removably connected to the lower end, support the loaded membrane elements, and allow connecting the lower cover to the lower end, to replace the temporary support.

18. A method of loading a vertical PV having a vertical axis, an upper end and a lower end with a plurality of membrane elements operable within the vertical PV in a single column, the method comprising:
defining a first end of the vertical PV as an insertion opening and a first membrane element to be inserted;
inserting the membrane elements into the insertion opening, beginning with the first membrane element such as to define a last membrane element; and
covering the upper end with an upper cover and the lower end with a lower cover, the covers comprising sealing means and pipe interfaces, to yield an operable desalination element.

19. The method of claim 18, wherein the first end is the upper end of the vertical PV, and the second end is the lower end of the vertical PV.

20. The method of claim 19, wherein the membrane elements are inserted into the insertion opening singly and sequentially.

21. The method of claim 20, wherein the membrane elements are supported on their downwards insertion by a device extending through the lower end and through the vertical PV.

22. The method of claim 20, wherein the membrane elements are supported on their downwards insertion by a device extending through the upper end and through the vertical PV.

23. The method of claim 19, further comprising interconnecting at least some of the membrane elements before their insertion, such that the membrane elements are inserted groupwise.

24-25. (canceled)

26. The method of claim 18, wherein the first end is a lower end of the vertical PV, and the second end is an upper end of the vertical PV.

27. The method of claim 26, wherein the membrane elements are inserted into the insertion opening singly and sequentially.

28. (canceled)

29. The method of claim 27, wherein the membrane elements are pulled upwards by a device extending through the upper end and through the vertical PV.

30. The method of claim 27, wherein the membrane elements are pushed upwards and temporarily supported at the lower end.
